(19) United States
(12) Patent Application Publication
(10) Pub. No.: US 2014/0109361 A1
(43) Pub. Date: Apr. 24, 2014

(54) LOAD BINDER AND METHOD OF USE

(71) Applicant: Steven M. Helline, Massillon, OH (US)

(72) Inventor: Steven M. Helline, Massillon, OH (US)

(21) Appl. No.: 13/798,654

(22) Filed: Mar. 13, 2013

Related U.S. Application Data
(60) Provisional application No. 61/717,996, filed on Oct. 24, 2012.

(51) Int. Cl. B60P 7/08

(52) U.S. Cl. CPC B60P 7/083
USPC 24/68 CD

(57) ABSTRACT

A ratchet type load binder and method is provided in which the load binder may be rapidly tightened or loosened by a motor and also manually tightened or loosened. The load binder may include different types of end linkages and may be used as a jack or lift for jacking a vehicle or lifting another type of load, or may be used as a spreading device for pushing two loads or objects away from one another.

### CROSS REFERENCE TO RELATED APPLICATION

This application claims priority from U.S. Provisional Application Ser. No. 61/717,996, filed Oct. 24, 2012; the disclosure of which is incorporated herein by reference.

### BACKGROUND OF THE INVENTION

1. Technical Field

The present invention is related generally to load binders and a method of using a load binder. More particularly, the invention is related to a threaded ratchet-type load binder which is configured for relatively rapid operation.

2. Background Information

Load binders are well known for securing loads to trailers, other wheeled vehicles, or in other contexts as well. Typically, the load binder has end links or linkages which include hooks, each of which an operator may hook onto a chain or other tie down member or tie down point in order to tighten the chain, strap or other tie down member which is typically wrapped around a load mounted on a trailer, etc.

Load binders come in several different types. One type of load binder is known as a lever-type load binder in which a lever is rotated or pivoted substantially along the plane in which the end links or linkages lie. These lever-type load binders typically include two pivots, one of which is pivotally linked to one end link and the other of which is pivotally linked to the other end link. While the lever-type load binders may be operated rapidly, they also pose a fairly significant risk of injuring the operator. It is well known by the operators of lever-type load $ binders that the lever may rotate rapidly under the stress of the load and hit the operator with substantial force.

Another type of load binder utilizes a ratchet system in which a sprocket is used to directly engage a chain of an end linkage whereby rotation of the sprocket tightens or loosens the chain and the ratchet mechanism secures the chain against loosening. Such a chain load binder is disclosed in U.S. Pat. No. 8,152,139 granted to Wang.

Ratchet-type load binders which use left handed and right handed threads in order to tighten or loosen the load binder have been known in the art for many years. For example, U.S. Pat. No. 3,338,359 granted to Baillie et al. discloses such a load binder. In addition, U.S. Pat. No. 7,055,804 granted to Scott discloses such a ratchet-type load binder which has a fold over handle. These ratchet-type load binders are generally safer for the operator to use than are the lever-type load binders. However, they operate rather slowly due to the necessity of rotating the threaded tube or housing multiple times in order to either tighten or loosen the load binder.

Thus, there is a need in the art for a ratchet-type load binder which may be operated more rapidly while providing the well-known safety aspects of the ratchet-type load binder.

### SUMMARY

In one aspect, the invention may provide a load binder comprising: a load binder rod having a load binder rod first end and a load binder rod second end with left hand threads adjacent the load binder rod first end and right hand threads adjacent the load binder rod second end; a first gear which is secured to the rod so that the rod and first gear are rotatable together about a first axis; a lever having a mounted position in which the lever is mounted on and extends outwardly from the rod away from the first axis so that the lever is configured to facilitate rotation of the rod and first gear about the first axis; and a second gear having a meshed position in which the second gear meshes with the first gear so that rotation of the second gear about a second axis causes rotation of the first gear and rod about the first axis.

In another aspect, the invention may provide a method comprising the steps of: providing a load binder which comprises a rod having first and second ends with left hand threads adjacent the first end and right hand threads adjacent the second end, a first gear secured to the rod, a first threaded end linkage which threadedly engages the left hand threads, and a second threaded end linkage which threadedly engages the right hand threads, wherein the rod and first gear are rotatable about a first axis; and rotating about a second axis a second gear meshed with the first gear to cause rotation of the first gear and rod about the first axis relative to the first and second threaded end linkages to cause one of (a) retraction of the first and second end linkages and (b) extension of the first and second end linkages.

In another aspect, the invention may provide a method comprising the steps of: providing a load binder which comprises a rod having first and second ends with left hand threads adjacent the first end and right hand threads adjacent the second end, a first threaded end linkage which threadedly engages the left hand threads, and a second threaded end linkage which threadedly engages the right hand threads; and rotating the rod with a motor so that rotation of the rod relative to the first and second threaded end linkages causes one of (a) retraction of the first and second end linkages and (b) extension of the first and second end linkages.

### BRIEF DESCRIPTION OF THE SEVERAL VIEWS OF THE DRAWINGS

Embodiments of the invention, illustrative of the best mode in which Applicant contemplates applying the principles, are set forth in the following description and are shown in the drawings and are particularly and distinctly pointed out and set forth in the appended claims.

FIG. 1 shows several load binders securing various loads on a flatbed trailer.

FIG. 2 is a perspective view of one configuration of a sample load binder or load binder assembly of the present invention.

FIG. 3 is a perspective view showing two end linkages of the load binder assembly.

FIG. 4 is a perspective view showing two different end linkages of the load binder assembly.

FIG. 5 is a sectional view taken on line 5-5 of FIG. 2.

FIG. 6 is a sectional view taken on line 6-6 of FIG. 2 and shows the ratcheting pawl in a neutral position.

FIG. 6A is similar to FIG. 6 and shows the ratcheting pawl in a tightening position.

FIG. 6B is similar to FIG. 6 and shows the pawl in a loosening position.

FIG. 7 is a sectional view taken on line 7-7 of FIG. 2 showing the grease fitting and associated components.

FIG. 8 is a sectional view from the same perspective as FIG. 5 showing the gear assembly mounted with bearings or bushings.

FIG. 9 is a perspective view showing the load binder assembly using end linkages having hooks with the end linkages in an extended position in preparation to tighten a tie down lanyard to secure a load.

FIG. 9A is similar to FIG. 9 and shows a drill being operated to rapidly tighten the load binder by retracting the end linkages in a relatively rapid fashion.

FIG. 9B is similar to FIG. 9A and shows the drill removed from the load binder and the load binder being manually operated to apply the final torque or tightening of the load binder.

FIG. 10 is a sectional view similar to FIG. 6 and shows a modified configuration in which the pawl is positioned to engage the driven gear.

FIG. 11 is a sectional view similar to FIG. 10 showing a modified configuration in which the pawl is positioned to engage the driven gear and the driving gear is mounted opposite the pawl with the driven gear therebetween.

FIG. 12 is a side elevation view showing the load binder being used as a jack or lift for jacking or lifting a vehicle wherein the load binder uses one end linkage with a hook and one end linkage with a foot.

FIG. 13 is a elevational view showing the load binder being used as a spreading mechanism with two end linkages each having a foot engaging components which are being spread apart from one another.

FIG. 14 is a perspective view of a removable motorized handle or lever of an alternate sample load binder assembly.

FIG. 15 is a perspective view of an extension-retraction assembly with which the removable motorized handle may be used.

FIG. 16 is a perspective view showing the removable motorized handle in a mounted position in which it is mounted on the extension-retraction assembly.

Similar numbers refer to similar parts throughout the drawings.

### DETAILED DESCRIPTION

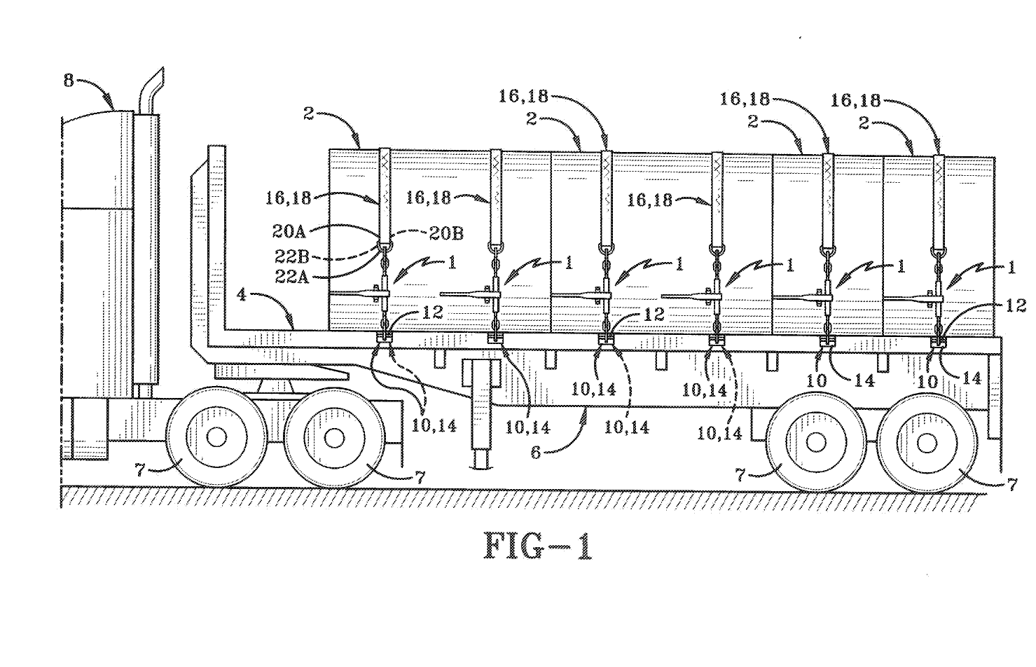

FIG. 1 shows a plurality of load binders securing several loads to the deck 4 of a flatbed trailer 6 which serves as a towed vehicle which is towed by a towing vehicle or tractor 8. Trailer 6 and tractor 8 each have ground engaging wheels 7 whereby each is a wheeled vehicle suited for over the road travel. Trailer 8 has several tie down points 10 each of which in the exemplary embodiment include a tie down connector shown here as a rod 12 which is secured to deck 4 whereby rod 12 and deck 4 define therebetween a hook receiving space 14. FIG. 1 also shows several tie down lanyards 16 each having a flexible elongated body 18 shown here in the form of a woven flexible strap although other flexible elongated bodies may be used such as chains, cables, ropes and the like. Each elongated body 18 has first and second ends 20A and 20B between which is elongated. Each of ends 20A is shown in solid on the left side of the loads 2 whereas ends 20B are on the right side of loads 2. Each lanyard 16 further includes a tie down connector 22 shown here in the form of a rigid ring or link typically made of metal. Each link 22 defines a hook receiving space 24.

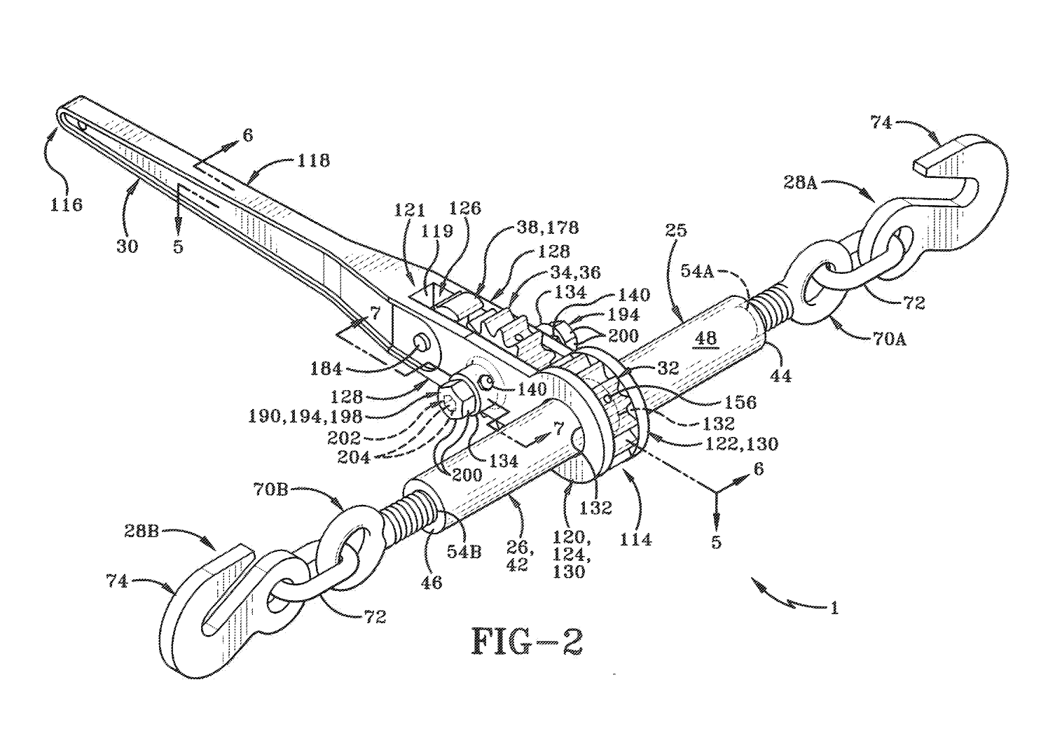

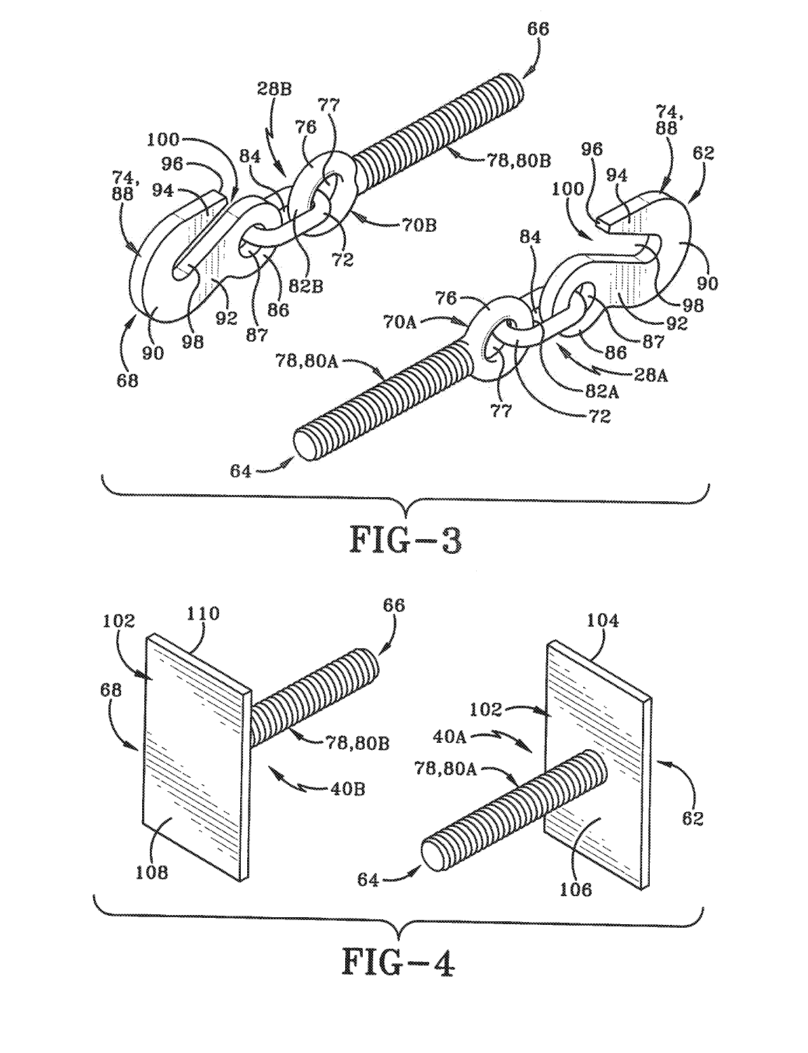

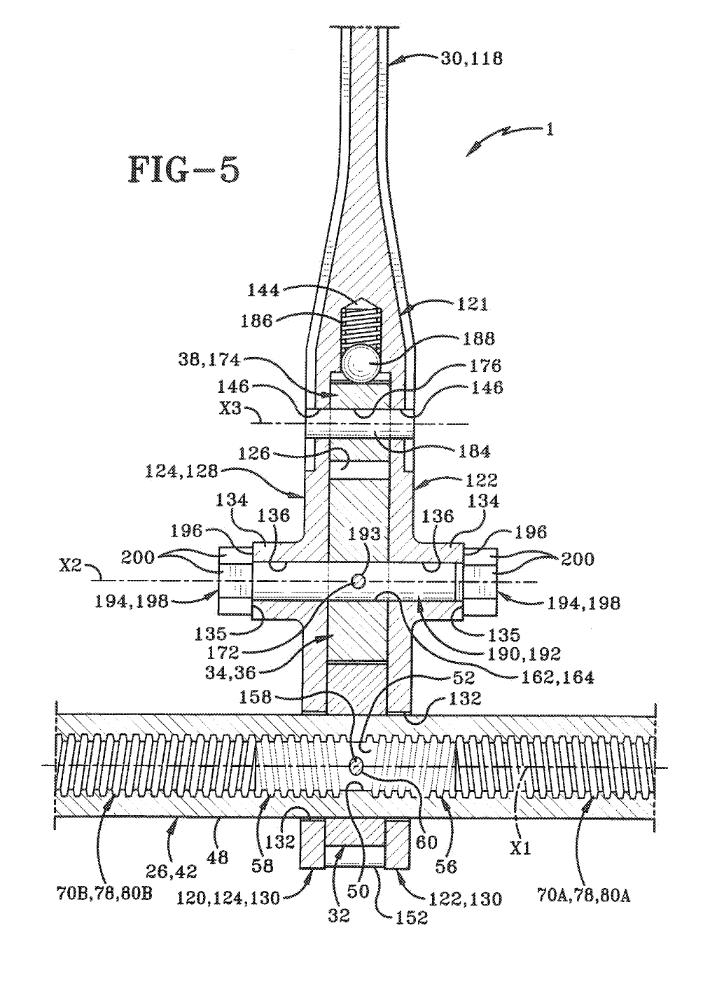

Referring primarily to FIG. 2, load binder or load binder assembly 1 is now described. Binder 1 includes an extension-retraction assembly 25 which includes a rigid straight rod 26 which is often referred to as a housing and in the sample embodiment is in the form of a rigid hollow tube formed of metal. Binder 1 further includes first and second or right and left end linkages 28A and 28B each formed of rigid components, a rigid lever 30, a rigid first or driven gear 32, a rigid second or drive gear 34, a gear assembly 36 and a rigid ratcheting pawl 38. In the sample embodiment, each of lever 30, gear 32, gear 34 and pawl 38 are formed entirely or primarily of metal. FIG. 3 shows the end linkages 28A and 28B separated from rod 26, while FIG. 4 shows first and second or right and left end linkages 40A and 40B. Load binder 1 may thus utilize two of the hook type end linkages shown in FIG. 3 together, two of the plate type end linkages shown in FIG. 4 together or one of the hook type end linkages with one of the plate type end linkages, as will be discussed in greater detail further below. Extension-retraction assembly 25, which may also be referred to as an extendable-retractable assembly, typically includes rod 26, driven gear 32, and a pair of end linkages which may be made up from end linkages 28A, 28B, 40A and 40B. Moreover, other types of end linkages may be used. Rod 26 and gear 32 are rotatable relative to lever 30, gear assembly 36 and pawl 38 about a first axis X1 (FIG. 5), and thus lever 30, gear assembly 36 and pawl 38 are rotatable relative to rod 26 and gear 32 about axis X1. Gear assembly 36 is rotatable relative to lever 30, rod 26, gear 32 and pawl 38 about a second axis X2 which is parallel to and offset from axis X1. Pawl 38 is pivotable about a third axis X3 which is parallel to and offset from axes X1 and X2. Axes X1, X2 and X3 may lie in a common plane.

With primary reference to FIGS. 2 and 5, load binder rod 26 includes an annular cylindrical side wall 42 having an annular first or right end 44 and an annular second or left opposed end 46. Rod 26 and side wall 42 are elongated between ends 44 and 46 in an axial direction of load binder 1. Side wall 42 has a cylindrical outer surface 48 which extends from end 44 to end 46 and a generally cylindrical inner surface 50 which likewise may extend from end 44 to end 46. Inner surface 50 defines a passage 52 extending from end 44 to end 46 having a right entrance opening 54A at end 44 and a left entrance opening 54B at end 46. Inner surface 50 includes internal right hand threads or an internal right hand threaded portion or section 56 extending inwardly to the left from right end 44 to adjacent the center of rod 26 midway between ends 44 and 46. Inner surface 50 likewise has internal left hand threads or an internal left hand threaded portion or section 58 extending inwardly to the right from end 46 to adjacent the center of rod 26. Side wall 42 defines a pin receiving hole 60 which may be at the center of rod 26 and side wall 42 midway between ends 44 and 46 and between the threaded sections 56 and 58. Hole 60 is a through hole which extends from inner surface 50 to outer surface 48.

With primary reference to FIGS. 2 and 3, end linkages 28A and 28B, which may be substantially mirror images of one another, are now described. Right end linkage 28A has a first or right or outer end 62 and a second or left or inner end 64 such that linkage 28A is axially elongated between ends 62 and 64. Linkage 28B has a first or right or inner end 66 and a second or left or outer opposed end 68 such that linkage 28B is axially elongated between ends 66 and 68. End linkage 28A includes a right hand or right handed eyebolt 70A, while left end linkage 28B has a left hand or left handed eyebolt 70B. Each eyebolt 70 is a rigid member and typically formed of metal. Each of end linkages 28A and 28B further includes a rigid link or ring 72 typically formed of metal and a rigid load engaging member in the form of a hook member 74 which is also typically formed of metal. Each eyebolt 70 includes an eye or ring 76 which typically serves as a closed loop defining a through hole 77. Each eyebolt further includes an axially elongated shaft or rod 78. The shaft 78 of right eyebolt 70A has external right hand threads or an external right hand threaded section 80A which extends from adjacent ring 76 to inner end 64. Shaft 78 of left eyebolt 70B has external left hand threads or an external left hand threaded section 80B extending from adjacent ring 76 to inner end 66. The threaded shaft or rod 78 of eyebolt 80A defines inner end 64, whereas the ring 76 of eyebolt 70A defines an opposed outer or right end 82A of eyebolt 70A. Threaded shaft 78 of eyebolt 70B defines inner end 66 whereas ring 76 of eyebolt 70B defines an opposed outer or left end 82B of eyebolt 70B. Each link 72 defines a through hole or passage 84 through which a portion of ring 76 passes. Likewise, a portion of link 72 passes through hole 77 so that link 72 is linked and movable relative to ring 76.

Each hook member 74 has a link or ring 86 defining a through hole 87, and a U-shaped hook 88 having a base 90, a first leg 92 and a second leg 94 having a terminal end 96. Base 90 and legs 92 and 94 define therebetween a space 98 having an entrance opening 100 adjacent terminal end 96. First leg 92 is rigidly secured to ring 86 and extends outwardly therefrom to a rigid connection with one end of base 90. Second leg 94 is rigidly secured to the opposite end of base 90 and extends outwardly therefrom to end 96 adjacent and spaced from ring 86.

Each plate type or foot type linkage 40 (FIG. 4) includes a substantially flat foot or plate 102 which serves as a load engaging member. Foot 102 of right end linkage 40A has a flat right or outer surface 104 which serves as a load engaging surface, and a flat left or inner surface 106 parallel to surface 104. Foot 102 of left end linkage 40B has a flat left or outer surface 108 which serves as a load engaging surface, and a flat right or inner surface 110 parallel to surface 108. In the sample embodiment, each foot or plate 102 is substantially flat and rectangular whereby each of flat surfaces 104, 106, 108 and 110 are flat and rectangular. Right end linkage 40A includes a linkage rod 78 having a right hand threaded section 80A. Rod 78 is rigidly secured to inner surface 106 (for instance by a weld) adjacent the middle or center of surface 106 and extends outwardly to the left therefrom such that the one end of rod 78 is rigidly secured to surface 106 and the other end 64 is distal surface 106 and defines the left end 64 of linkage 40A while the outer surface 104 defines the outer end 62 of linkage 40A. Plate 102 of end linkage 40A and surfaces 104, 106 thus extend radially outwardly away from the outer end of rod 64 in all directions. Because plate 102 may be rigidly fixedly secured to rod 78, end linkage 40A may be a rigid member or unit. Left end linkage 40B has a similar configuration except that the rod 78 thereof includes left hand threads 80B and extends outwardly to the right from surface 110. End linkages 40A and 40B may be substantially mirror images of one another.

The right hand threads 80A of end linkage 28A or 40A may threadedly engage the right hand threads 56 of rod 26 (such as shown in FIG. 5), and thus be threaded or screwed into threads 56 and unthreaded or unscrewed from threads 56. Likewise, the left hand threads 80B of end linkage 28B or 40B may threadedly engage the left hand threads 58 of rod 26, and thus be threaded or screwed into threads 58 and unthreaded or unscrewed from threads 58. It is further noted that the internal and external threads may be reversed. That is, an alternate rod analogous to rod 26 may be formed with external left and right hand threads, alternate left hand threaded rods analogous to the left hand threaded rods 78 may be formed as hollow tubes (similar to rod 26) with internal left hand threads to provide a threaded engagement with the external left hand threads of the alternate rod, and alternate right hand threaded rods analogous to the right left hand threaded rods 78 may be also formed as hollow tubes with internal right hand threads to provide a threaded engagement with the external right hand threads of the alternate rod.

Referring primarily to FIGS. 2 and 5, lever 30 has a first, inner or front end 114 and a second, outer or rear end 116 between which handle 30 is longitudinally elongated and substantially straight. Lever 30 has a mounted position in which lever 30 adjacent front end 114 is mounted on and rotatable relative to rod 26. Ends 114 and 116 define therebetween a longitudinal direction of handle 30 and of load binder 1. Handle 30 includes an outer or rear segment 118 which serves as a manual grip section having an inner or front end or surface 119. Handle 30 further includes an inner or front segment 120 which extends forward from front end 119 to a terminal end represented by end 114. Rear segment 118 includes a detent mount 121 adjacent front end 119. Front segment 120 includes a first or right fork or arm 122 and a second or left fork or arm 124 which are generally straight, longitudinally elongated and extend forward from front end 119 to end 114. Bars or arms 122 and 124 define therebetween a space 126 extending from surface 119 to front end 114 and from the top to the bottom of each of the forks. Each arm 122 and 124 includes a gear and/or pawl mounting segment 128 which is a substantially straight arm segment. Each arm 122 and 124 also includes a rod mounting segment or ring 130 which defines a through hole 132 serving as a rod receiving hole or passage. In the mounted position of lever 30, the left and right holes or passages 132 receive therein respective portions of rod 26 immediately to the left and right of gear 32 and lever 30 extends longitudinally outwardly away from rod 26 to rear end 116 so that end 166 is distal rod 26 and front end 114 is adjacent rod 26. In the sample embodiment, lever 30 is substantially perpendicular to rod 26.

An annular boss 134 is rigidly secured to and extends outwardly from the outer surface of segment 128 of each arm 122 and 124. Annular bosses 134 thus include a left annular boss and a right annular boss. The left annular boss 134 extends outwardly to the left from the left surface of arm 122 to a flat annular terminal end surface 135. Similarly, the right annular boss extends outwardly to the right from the right outer surface of right arm 122 to a flat annular right terminal end surface 135. Left and right bosses 134 thus extend outwardly away from one another on left and right sides of the handle and are axially aligned with one another. Bosses 134 and portions of segments 128 define a gear axle passage 136 extending from the right end surface 135 of the right boss 134 to the left annular end surface 135 of the left boss 134. Lever 30 thus includes a gear mount on which gear assembly 36 is rotatably mounted and which may include portions of bars or arms 122 and 124 and bosses 134.

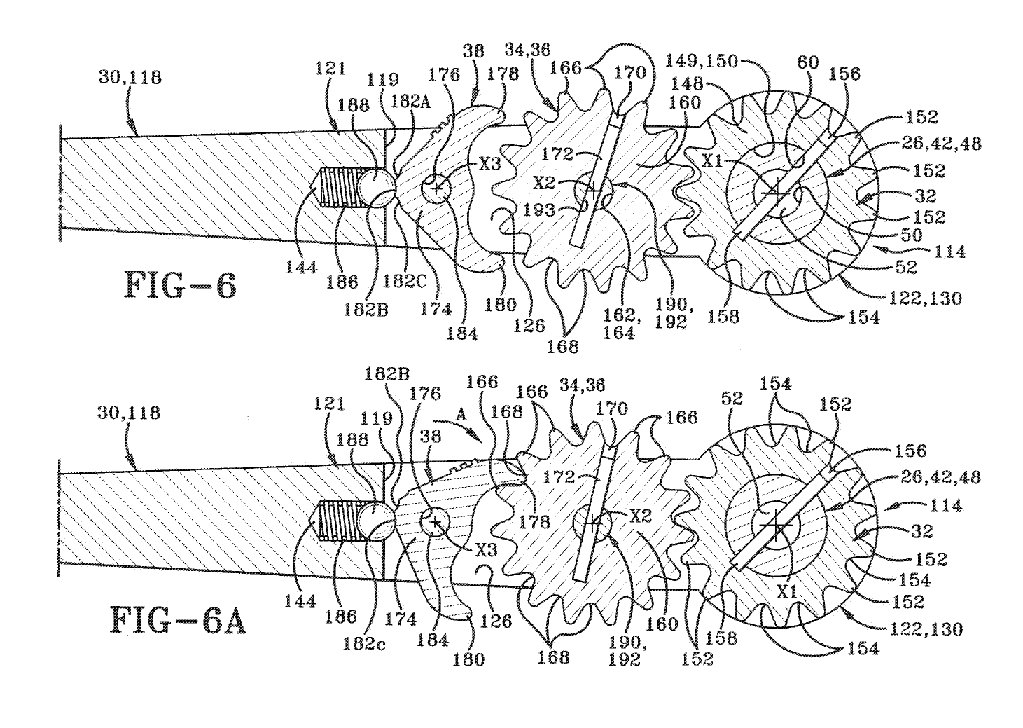

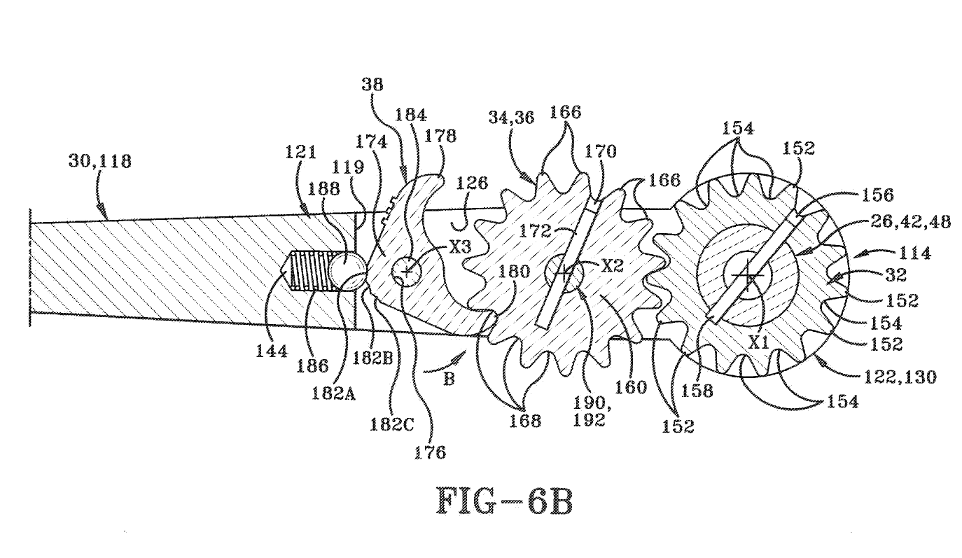

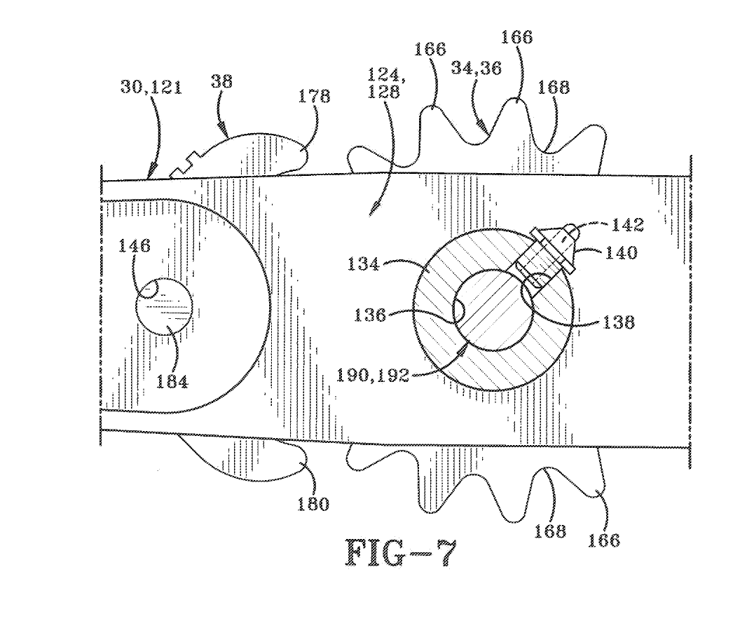

Jumping to FIG. 7, each boss further defines a grease fitting mounting hole 138 which extends from the annular generally cylindrical outer surface of the boss 134 to the generally cylindrical inner surface of the given boss 134. Hole 138 thus communicates with passage 136 and receives therein a portion of a grease fitting 140. Each grease fitting 140 defines a grease passage 142 extending from one end or nipple or an outer surface of fitting 140 to an inner end or inner surface of fitting 140, wherein the outer end or outer surface of the fitting 140 is outside or external to the given boss 134 and the inner end or surface of fitting 140 is within passage 138 of boss 134. Grease passage 142 thus is in fluid communication with passage 138 and passage 136. Thus, a grease gun may be connected to the nipple of the grease fitting to inject grease through passage 142 into passage 138 and passage 136 to lubricate axle assembly 36 within passage 136. A detent hole or spring receiving hole 144 (FIG. 6) is formed in detent mount 121 and extends rearwardly from surface 119 a short distance to an internal terminal end within section 121. Segments 128 define a pawl axle passage 146 extending from the left side or surface of the left segment 128 to the right side or surface of the right segment 128.

With primary reference to FIG. 6, the first or driven gear 32 includes an annular body 148 having a cylindrical inner surface 149 which defines a cylindrical rod receiving hole or passage 150. A plurality of gear teeth 152 are rigidly secured to and extend radially outwardly from body 148 and away from axis X1 all along the outer perimeter of body 148 such that each adjacent pair of teeth 152 defines therebetween a recess 154. Gear 32 defines a radially extending pin receiving hole 156 which extends inwardly from an outer perimeter of gear 32 between a pair of adjacent teeth 152 and through a portion of body 148. Hole 156 is typically straight and lies along a radius or diameter perpendicular to axis X1 and the length of rod 26. Hole 156 and hole 60 of rod 26 are aligned with one another and receive therein a straight securing pin 158 which rigidly secures gear 32 to rod 26 such that gear 32 is fixed relative to rod 26 and thus is rotatable therewith about axis X1.

With continued primary reference to FIG. 6, drive gear 34 includes an annular body 160 having a cylindrical inner surface 162 defining a cylindrical passage 164. Gear 34 further includes gear teeth 166 which are rigidly secured to and extend radially outwardly from annular body 160 and away from axis X2 such that each adjacent pair of teeth 166 defines there between a recess 168. Gear 34 defines a pin receiving hole 170 which is substantially straight and extends inwardly from the outer perimeter of gear 34 between an adjacent pair of teeth 166 and through a portion of a body 160 in communication with passage 164. Hole 170 is radially elongated and substantially straight and lies along a radius perpendicular to axis X2. Hole 170 is configured to receive a straight securing pin 172. Gears 32 and 34 mesh with one another in a meshed position such that teeth 166 of gear 34 are receivable within respective recesses 154 of gear 32 and teeth 152 of gear 32 are receivable within recesses 168 of gear 34. Thus, rotation of gear 34 about axis X2 in one direction drives rotation of gear 32 and rod 26 about axis X1 in an opposite direction.

With continued primary reference to FIG. 6, pawl 38 includes an annular body 174 defining an axle passage 176, a first pawl arm 178 which is rigidly secured to and extends outwardly, upwardly and forward from body 174 while a second pawl arm 180 extends outwardly, downwardly and forward from body 174 in a generally opposite direction from first pawl arm 178. Body 174 along its back end, defines detent members, recesses or surfaces 182A, 182B and 182C such that detent member 182B is adjacent and between detent members 182A and 182C. Detent member or surface 182B is a neutral detent member or surface, whereas detent member or surface 182C is a forward or tightening detent member or surface, and detent member or surface 182A is a reverse or loosening detent member or surface. Each of detent members 182 is defined by an outer rearward surface of body 174 wherein each of said surfaces is concavely curved as viewed from the side and generally faces rearwardly. Axle passage 176 receives there through a pawl axle 184 by which pawl 38 is pivotally mounted on lever 30 such that pawl 38 is pivotable about axis X3, which is rearward of axes X1 and X2. A coil spring or compression spring 186 is received within cavity 144 along with a ball or detent member 188 such that one end of spring 186 abuts a rearward end defining hole 144 and the other end of spring 186 engages ball 188 and biases ball 188 forward against a given one of detent members 182 of annular body 174, thus providing a detent which releasably holds or secures pawl 38 in a respective one of the pawl or detent positions shown in FIGS. 6, 6A and 6B and discussed below. Spring 186 is thus operatively connected to pawl 38.

Pawl 38 has a neutral position shown in FIG. 6, a forward or tightening ratchet position shown in FIG. 6A and a reverse or loosening ratchet position shown in FIG. 6B. Pawl 38 is pivotable about axis X3 to move between its neutral, tightening and loosening positions. In its neutral position (FIG. 6), pawl 38 is disengaged from and out of contact with gear 34, and detent member 188 engages detent member or surface 182B so that the detent holds pawl 38 in the neutral position, thus preventing pawl 38 from moving out of the neutral position absent a force (such as a manual force) on pawl 38 which is sufficient, via rotation of pawl 38 about axis X3, to overcome the force applied by spring 186 on detent member 188 against detent member 182B.

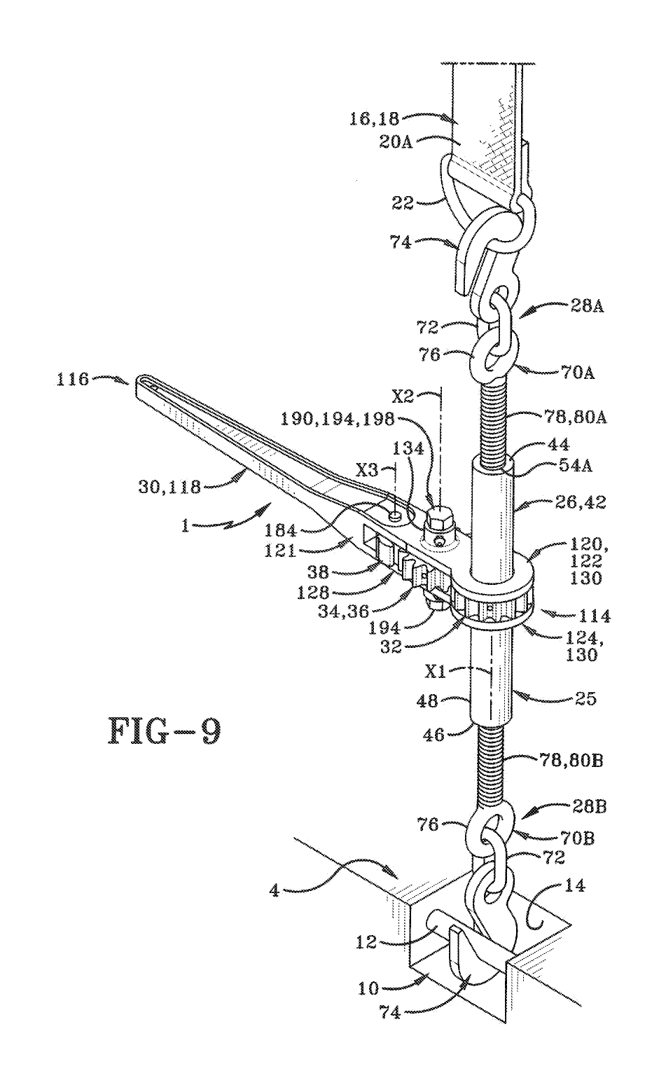

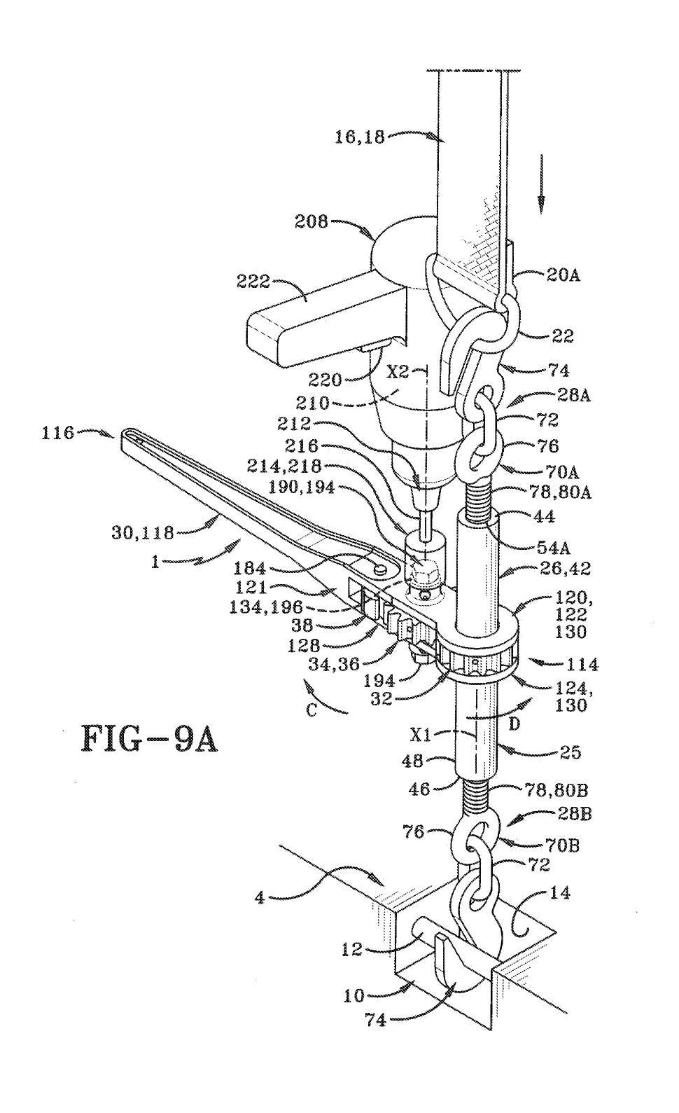

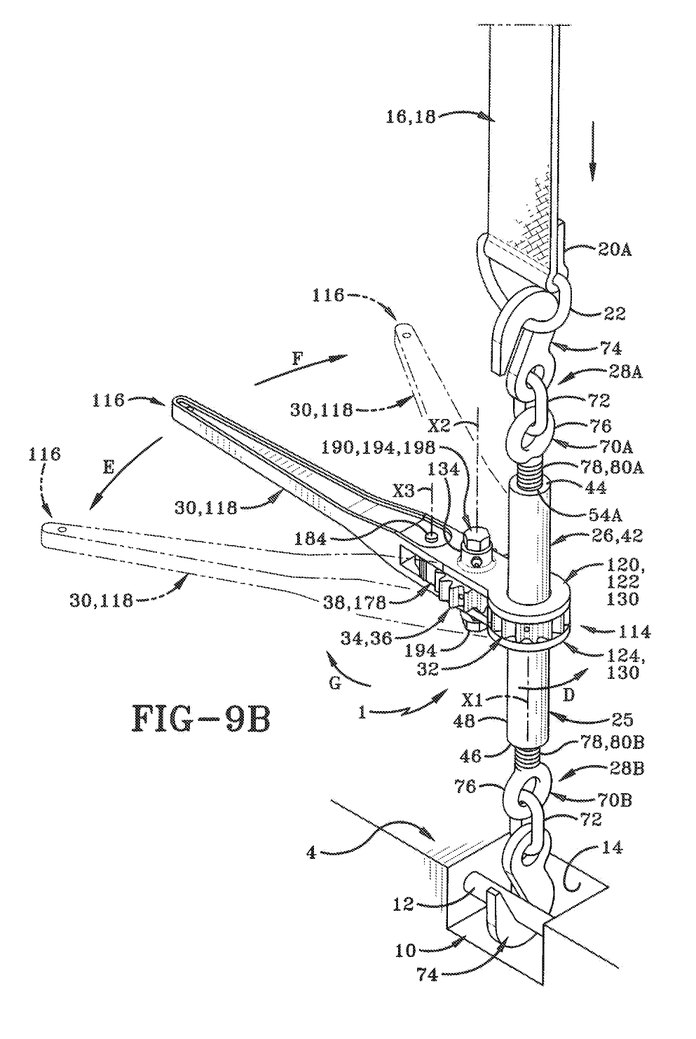

In its tightening ratchet position (FIG. 6A), detent member 188 engages detent member or surface 182C so that the detent holds pawl 38 in the tightening position, thus preventing pawl 38 from moving out of the tightening position absent a force (such as a manual force) on pawl 38 which is sufficient, via rotation of pawl 38 about axis X3, to overcome the force applied by spring 186 on detent member 188 against detent member 182C. Also in the tightening ratchet position of pawl 38, when a tightening force is applied to lever 30 so that lever 30 rotates about axis X1 and drives tightening rotation of rod 26 about axis X1 in a tightening direction (as discussed further below with reference to FIG. 9B), first pawl arm 178 of pawl 38 is within one of recesses 168 and engages the two teeth 166 of gear 34 which define that recess 168. In the tightening ratchet position of pawl 38, when a ratcheting force opposite the tightening force is applied to lever 30 so that lever 30 rotates relative to rod 26 about axis X1 in a ratcheting direction opposite the tightening direction, pawl 38 moves in a ratcheting fashion such that, as gear 34 rotates about axis X2 relative to lever 30 (in a clockwise direction from the perspective of FIG. 6A), pawl 38 pivots back and forth about axis X3 relative to lever 30 and gear 34 as first pawl arm 178 serially slidably engages teeth 166 and serially moves into and out of recesses 168.

In its loosening ratchet position (FIG. 6B), detent member 188 engages detent member or surface 182A to hold pawl 38 in the loosening position, thus preventing pawl 38 from moving out of the loosening position absent a force (such as a manual force) on pawl 38 which is sufficient, via rotation of pawl 38 about axis X3, to overcome the force applied by spring 186 on detent member 188 against detent member 182A. Also in the loosening ratchet position of pawl 38, when a loosening force (opposite the tightening force) is applied to lever 30 so that lever 30 rotates about axis X1 and drives loosening rotation of rod 26 about axis X1 in a loosening direction (opposite the tightening direction) second pawl arm 180 of pawl 38 is within one of recesses 168 and engages the two teeth 166 of gear 34 which define that recess 168. In the loosening ratchet position of pawl 38, when a ratcheting force opposite the loosening force is applied to lever 30 so that lever 30 rotates relative to rod 26 about axis X1 in a ratcheting direction opposite the loosening direction, pawl 38 moves in a ratcheting fashion such that, as gear 34 rotates about axis X2 relative to lever 30 (in a counterclockwise direction from the perspective of FIG. 6B), pawl 38 pivots back and forth about axis X3 relative to lever 30 and gear 34 as second pawl arm 180 serially slidably engages teeth 166 and serially moves into and out of recesses 168.

With primary reference to FIG. 5, gear assembly 36 includes gear axle 190 having an axially elongated substantially straight shaft 192 with left and right end portions or enlarged heads 194 rigidly secured to the opposed left and right ends of shaft 192 and extending radially outwardly therefrom beyond the cylindrical outer surface of shaft 192 which defines its outer diameter. Each head 194 has an inner surface 196 which respectively engages or is closely adjacent end surfaces 135 of bosses 134. Heads 194 thus includes left and right heads such that the inner surface 196 of the left head is a rightward facing surface and the inner surface 196 of the right head 194 is a leftward facing surface. During rotation of gear assembly 36 about axis X2 relative to lever 30, the cylindrical outer surface of shaft 192 may slidably engage the respective inner surfaces of bosses 134 and arms 122 and 124 which define passage 136. Also during the rotation of gear assembly 36 about axis X2 relative to lever 30, the rightward facing surface 196 of left head 194 may slidably engage the leftward facing end surface 135 of left boss 134, and the leftward facing surface 196 of right head 194 may slidably engage the rightward facing end surface 134 of right boss 134. Each of heads 194 likewise includes a generally flat outer surface 198 such that the outer surface 198 of the left head faces leftward and the outer surface 198 of the right head faces rightward and thus away from the outer surface of the left head. Heads 194 in the sample embodiment include a plurality of external flats 200 defining an outer perimeter of the given head 194. In the sample embodiment, the flats 200 define a hexagonal shape such as found on a standard hexagonal bolt head. FIG. 2 also shows in dashed lines that each head 194 may define a torque hole defined by internal flats 204 which form an inner perimeter defining hole 202. It will be understood that the outer perimeter 200 may have a different shape than hexagonal, such as square, by way of example only. The outer perimeter typically includes at least one flat such as flat 200, thus providing a torque drive surface for driving rotation of gear axle 190 and gear 34 about axis X2. Similarly, where a torque hole such as hole 202 is used, it need not be hexagonal, but may also be square or another shape and typically includes one or more flats such as flats 204, thus providing a torque drive surface for driving rotation of axle 190 and gear 34 about axis X2. One of skill in the art will understand that various types of torque drive surfaces may be provide on either of or both of end portions or heads 194. Another common example of a torque hole may be a star-shaped hole instead of the hexagonal hole shown. In addition, a plurality of holes may be formed in one or both of heads 194 wherein such holes may even be circular to receive therein a mating tool for applying torque to axle 190. Moreover, the end surfaces or outer surfaces 198 of heads 194 may be formed in order to provide desirable torque drive surfaces, such as with teeth which extend outwardly in the axial direction to be engaged by a tool with a mating configuration. Generally speaking, it is desired that the torque drive surface not have a circular configuration which is concentric about axis X2, and that the torque drive surface not be a substantially flat surface which is perpendicular to axis X2. However, for example, even a circular or cylindrical surface which is concentric about axis X2 may provide a torque drive surface such as may be clamped by a drill chuck or other tool.

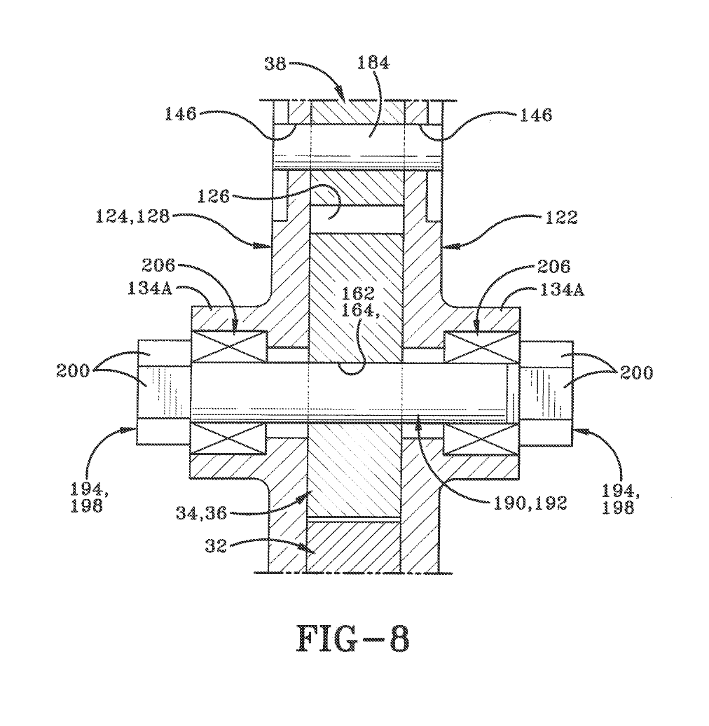

Turning briefly to FIG. 8, the load binder is illustrated with modified annular bosses 134A configured to receive therein left and right bushings or bearings 206 which define axle passages for receiving there through shaft 192 of gear axle 190. In this configuration, axle 190 and gear 34 are rotatably mounted on lever 30 via bushings or bearings 206 to rotate about axis X2.

The load binder assembly may include or be used in conjunction with a motor for driving the rotation of axle 190 and gear 34, such as a drill 208, which is shown in FIG. 9A and may be a cordless drill. Drill 208 includes an electric motor 210, a rotational output or chuck 212 which is rotatably driven by motor 210 and which is configured to be releasably secured to a torque drive member 214 having, for example, a shaft 216 and a socket 218. More particularly, chuck 212 may be releasably secured to shaft 216 in order to drive rotation of torque drive member 214 when the drill 208 is operated. Drill 208 further includes an on/off switch or button 220 mounted on a handle 222 which extends outwardly from the body or housing of the drill which houses motor 210. Drill 208 typically also includes a forward and reverse switch in order to allow the rotation of the rotational output 212 and torque drive member 214 to rotate in a forward or reverse direction or in a clockwise or counterclockwise direction. Although drill 208 typically includes an electric motor, a different type of motor may be used to the same effect described in greater detail below. Thus, a fuel powered motor, a pneumatic motor, a hydraulic motor and so forth may be used in order to provide rotational output in essentially the same manner as with motor 210.

The operation of the load binder assembly is now described with primary reference to FIGS. 9, 9A and 9B. FIG. 9 shows load binder 1 in an extended position whereas FIG. 9A shows the load binder in a retracted position or a more retracted position than shown in FIG. 9, while FIG. 9B shows the load binder in an even more retracted position which is more retracted than in FIG. 9A. The position of FIG. 9 may also be referred to as a loosened position, whereas the position of FIG. 9A may be referred to as a partially tightened position, and the position of FIG. 9B may be referred to as a fully tightened position. More particularly, each of the end linkages 28A and 28B extend outwardly in the axial direction beyond respective ends 44 and 46 of rod 26 in FIG. 9 further than they do in either of FIG. 9A and FIG. 9B. Likewise, end linkages 28A and 28B extend outwardly in the axial direction beyond ends 44 and 46 respectively somewhat further than they do in FIG. 9B. It may also be said that extension-retraction assembly 25 is longer in the extended position of FIG. 9 than it is in the partially and fully tightened positions of FIG. 9A and FIG. 9B, and that assembly 25 is longer in the partially tightened position of FIG. 9A than in the fully tightened position of FIG. 9B. The relative lengths referred to are axial lengths parallel to axis X1 and could be compared by the length defined between the outer ends of hooks 74, or for instance, between the outer ends of eyebolts 70 or other arbitrary points. Thus, for instance, the axial length defined between the outer ends of hooks 74 is greater in FIG. 9 than in FIG. 9A and FIG. 9B, and is greater in FIG. 9A than in FIG. 9B, and likewise the lengths defined between the outer ends of eyebolts 70 is greater in FIG. 9 than in FIGS. 9A and 9B, and is greater in FIG. 9A than in FIG. 9B. For purposes of description, the position shown in FIG. 9 may be referred to as the extended position, whereas the position of FIG. 9A may be referred to as the intermediate position and FIG. 9B referred to as the retracted position, although it will be understood that these positions or degrees of extension and retraction are relative to one another.

In order to tighten the load binder or move it from the extended position of FIG. 9 to the intermediate position of FIG. 9A, pawl 38 may be manually moved to the neutral position of FIG. 6 from the forward or reverse positions of FIGS. 6A and 6B if pawl 38 is not already in the neutral position. Although it is generally desired that pawl 38 be in the neutral position prior to the use of drill 208 described hereafter, pawl 38 may be in one of the ratchet positions which allows for rotation of gear 34 in a clockwise direction with pawl 38 moving in a ratcheting fashion or in the other ratchet position which allows for the rotation of gear 34 in a counterclockwise direction with pawl 38 moving in a ratcheting fashion, and still allow for the use of drill 208 for rotation of gear assembly 36 in the corresponding directions. The operator will then, preferably while pawl 38 is in the neutral position, manually position drill 208 so that torque drive member 214 rotationally engages one of heads 194 in a manner to allow the transfer of torque from member 214 to head 194 and thus to axle 190 and gear 34 during rotation of rotational output 212 and member 194. In the sample embodiment, head 194 is received within socket 218 to this effect. While pawl 38 is in the neutral position, the operator may set drill 208 to rotate in the desired direction and then press button 220 to cause motor 210 to operate, thus rotating rotational output 212, torque drive member 214, axle 190 and gear 34 about axis X2 in the direction shown at Arrow C in FIG. 9A. The rotation of gear 34 in the direction of Arrow C causes rotation of gear 32 and rod 26 about axis X1 in the opposite direction as indicated at Arrow D in FIG. 9A. This tightening rotation of rod 26 thus causes the retraction of end linkages 28A and 28B via the threaded engagement between the right hand threads of rod 26 and end linkage 28A and the threaded engagement of the left hand threads of rod 26 and end linkage 28B. It may also be said that the rotation of rod 26 in the direction of Arrow D causes the shortening of assembly 25, or a decrease in the axial length of assembly 25. The use of drill 208 in conjunction with gear assembly 36 drastically increases the rate of rotation of gear 32 and rod 26 compared to the manual ratcheting of a standard load binder and thus the rate at which end linkages 28 are retracted and assembly 25 is shortened. The rotation of gear assembly 36 with drill 208 may, and typically does, occur while lever 30 is manually held generally stationary and generally against rotation about axis X1 relative to extension-retraction assembly 25.

Depending on the torque which may be applied by the drill or other motor to gear assembly 36, the load binder may or may not need additional tightening in order to secure the load properly. Where such additional tightening or torquing of the load binder is necessary, pawl 38 may then be moved to the tightening torquing or ratcheting position shown in FIG. 6A with first pawl arm 178 received within one of recesses 168 of gear 34, and detent member or ball 188 engaging detent member 182C. With pawl 38 in this tightening ratcheting position, the operator may move lever 30 in the direction shown in Arrow E in FIG. 9B by applying a manual force (also represented by Arrow E) on grip section 118 of lever 30, thus additionally tightening or retracting linkages 28 and further shortening assembly 25 by causing rotation of gear 32 and rod 26 in the direction of Arrow D shown in FIG. 9B. When pawl 38 is in the tightening position shown in FIG. 9B and lever 30 is being moved in the direction of Arrow E, pawl 38 locks gear 34 against the rotation of gear 34 about axis X2 relative to lever 30 whereby lever 30, pawl 38, gear assembly 36 including gear 34 and axle 190, gear 32 and rod 26 all are fixed relative to one another such that they rotate together as a unit about axis X1 in the direction shown in Arrow D in FIG. 9B. This rotational movement thus tightens or further retracts the end linkages 28A to tighten the tie down lanyard 16 and thus further secure the load. If additional tightening or retracting is necessary, the operator may then manually move handle 30 in the opposite rotational direction shown by Arrow F by applying a manual force (also represented by Arrow F) on grip section 118 of lever 30 in a ratcheting fashion in order to thereafter once again move handle 30 in the direction of Arrow E for additional tightening. During the movement of lever 30 in the direction of Arrow F, lever 30, gear assembly 36 and pawl 38 rotate relative to gear 32 and rod 26 about axis X1 in the direction of Arrow F, while gear 34 and axle 190 rotate about axis X2 in the direction shown by Arrow G as teeth 166 of gear 34 move into and out of respective recesses 154 of gear 32, and as pawl arm 178 serially ratchets in and out of recesses 168 of gear 34 during the back and forth pivotal movement of pawl 38 about axis X3. The driving and tightening movement of Arrow E and the opposite ratcheting movement of Arrow F are thus alternated until load binder 1 is sufficiently tightened. Typically, the operator will only need to manually apply a few tightening strokes to lever 30 in order to effect this final tightening, retracting or shortening to reach the fully tightened position of FIG. 9B after the motorized tightening achieved as shown in FIG. 9A.

To loosen, lengthen or extend the load binder, the tightening process is essentially reversed. Thus, if it is necessary to manually loosen, extend or lengthen binder 1, pawl 38 would be moved manually to the loosening torquing or ratcheting position shown in FIG. 6B such that rotation of lever 30 in the direction shown in Arrow F would cause the rotation of gear 32 and rod 26 along with gear assembly 36 and pawl 38 about axis X1 in the direction opposite Arrow D in FIG. 9B relative to the end linkages 28 in order to unthread or unscrew them from the respected threaded portions of rod 26, thus extending or elongating binder 1. When pawl 38 is in the loosening position shown in FIG. 6B and lever 30 is being moved in the direction of Arrow F, pawl 38 locks gear 34 against the rotation of gear 34 about axis X2 relative to lever 30 whereby lever 30, pawl 38, gear assembly 36 including gear 34 and axle 190, gear 32 and rod 26 are all fixed relative to one another such that they rotate together as a unit about axis X1 in the direction shown at Arrow F. If necessary, lever 30 may then be moved in a ratcheting direction (Arrow E) during which rod 26 and gear 32 remain generally stationary, gear assembly 36 rotates relative to lever 30 about axis X2 in the direction opposite Arrow G and pawl 38 pivots back and forth in a ratcheting fashion about axis X3 with pawl arm 180 (FIG. 6B) serially moving into and out of the recesses 168 of gear 34 and serially engaging teeth 166. Once the binder has been sufficiently loosened to be driven by motor 210 of drill 208 or another motor, the motor is operated to rotate rotational output 212 and torque drive member 214 in the direction opposite Arrow C (FIG. 9A) to drive the rotation of gear 32 and rod 26 in the direction opposite Arrow D to rapidly unthread and extend end linkages 28 from the position shown in FIG. 9A to the position shown in FIG. 9 and thus rapidly loosen or lengthen assembly 25. When load binder 1 is sufficiently loosened or extended, hooks 74 may be removed from tie down connector 22 and tie down connector 12 and lanyard 16 may be removed from the given load 2 (FIG. 1).

FIG. 10 shows a slightly modified version of the load binder in which pawl 38 is located in a different position in order to engage gear 32 instead of engaging gear 34. Thus, in contrast to the configuration shown in FIG. 6 in which gear 34 is intermediate and directly between 32 and pawl 38, the configuration of FIG. 10 shows that gear 32 is intermediate and directly between gear 34 and pawl 38, and that pawl 38 is mounted on a portion of lever 30A forward of rod 26 and thus on the opposite side of the gripping section or rear segment 118 of lever 30A. The rear segment of lever 30A has a front end or surface 119A which is analogous to surface 119 and is further forward on lever 30A than is surface 119 of handle 30. Lever 30A includes a detent mount 121A which is at the front end of lever 30A and thus on the opposite side of rod 26 from the gripping section of lever 30A. Mount 121A thus defines a cavity or hole 144A for receiving spring 186 and ball or detent member 188 in the same manner as previously discussed except that cavity 144A opens rearwardly and spring 186 biases detent member 188 rearwardly into the, respective pawl 38 detent members 182, which face forward instead of rearward. Lever 30A includes a forward section including a pair of forks, bars or arms defining therebetween a space 126A in which is disposed gears 32 and 34 and pawl 38. Space 126A is bounded on either end by surface 119A and the rear surface of mount 121A. The basic operation of the load binder using the configuration shown in FIG. 10 is essentially the same as that previously described with respect to FIGS. 9, 9A and 98 except that pawl 38 does not engage with gear 34, but does engage with gear 32 during the period that it is needed to manually tighten/retract or loosen/extend the end linkages 28. As with the previous description of the load binder using lever 30, the load binder using lever 30A still allows for the use of a motor such as provided by a drill 208 to rapidly drive rotation of gear 34, which in turn causes rapid rotation in the opposite direction of gear 32 and rod 26 and thus the rapid extension or retraction of linkages 28.

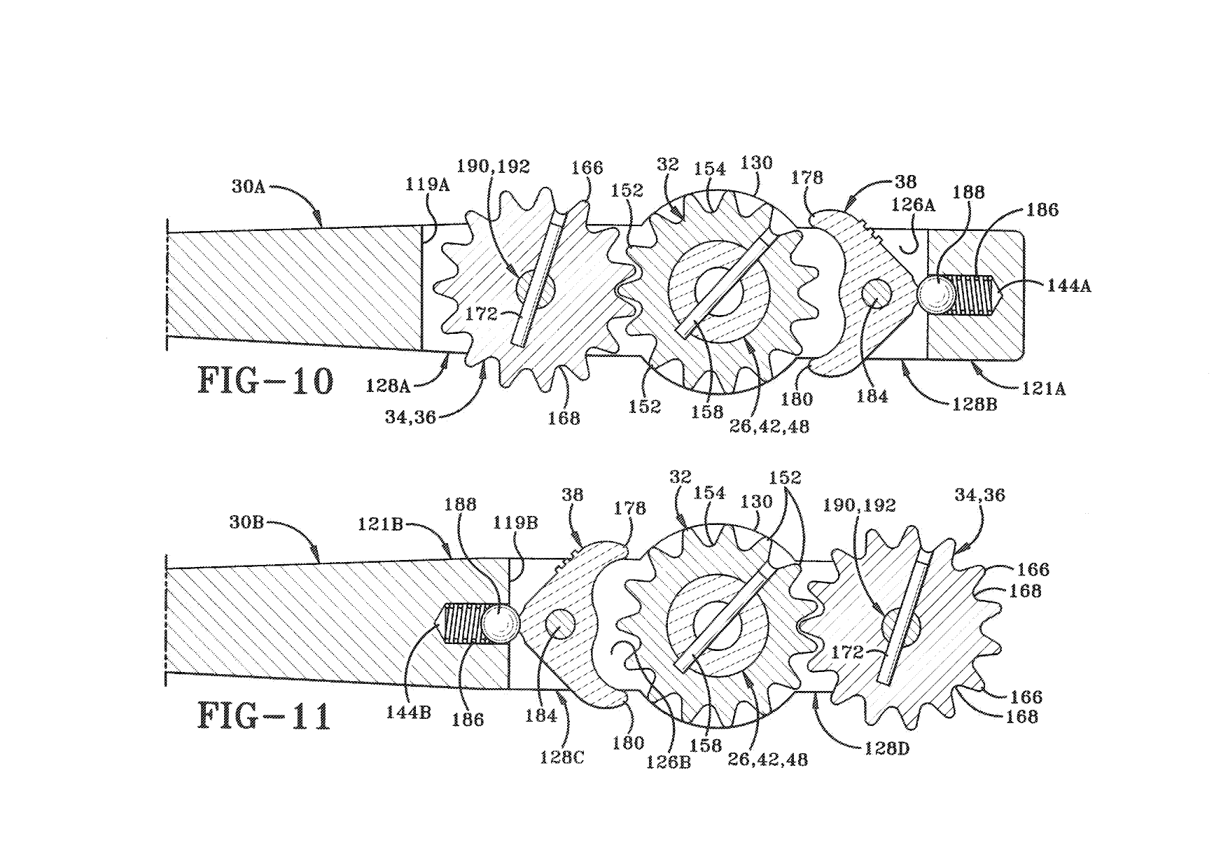

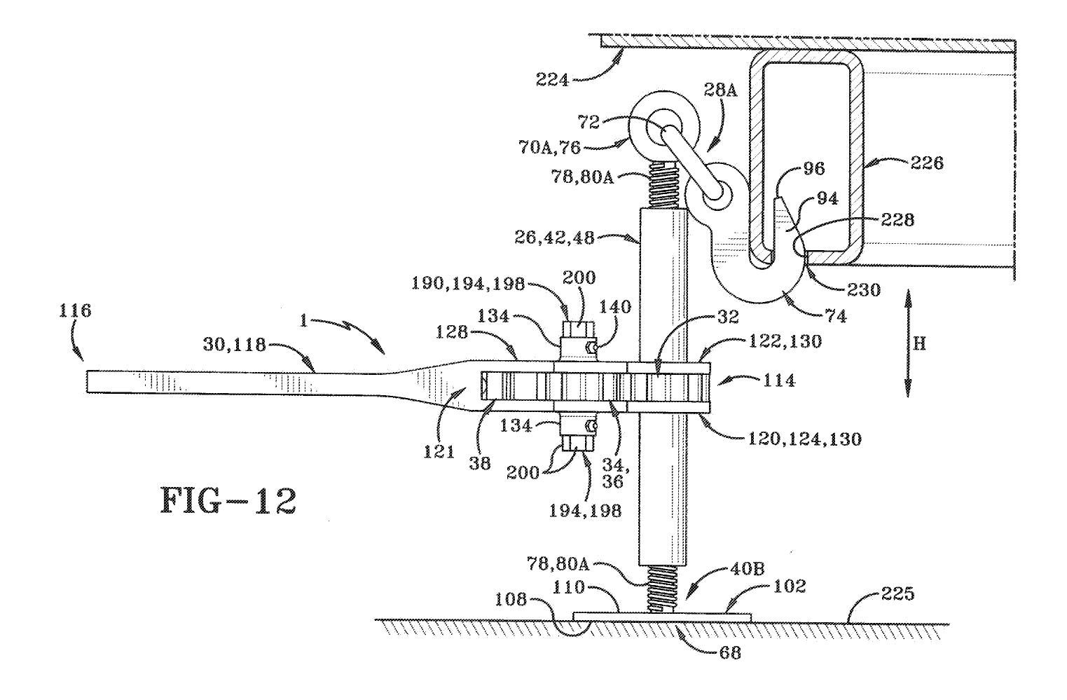

FIG. 11 shows another modification of the load binder including a lever 30B having a grip section which has a front end 1198 analogous to and further forward than surfaces or ends 119 and 119A. This modification shows drive gear 34 mounted on the front of lever 30A on an opposite side of gear 32 and tube 26 from pawl 38 such that gear 32 is directly between pawl 38 and gear 34, gear 34 is forward of gear 32 and rod 26, and pawl 38 is rearward of gear 32 and rod 26. Lever 30B includes a detent mount 1218 in which is formed a cavity 1448 extending rearwardly from surface 119B in receiving spring 186 and ball 188 therein so that spring 196 biases ball 188 forward into the detent surfaces 182 of pawl 38. Similar to the modification of FIG. 10, pawl 38 is positioned to engage gear 32 and not engage gear 34. The operation of a load binder using lever 30B is essentially the same as previously described, and similar to the load binder using lever 30A, pawl 38 engages gear 32 when necessary to provide the respective driving and ratcheting and respective clockwise and counterclockwise directions for manually loosening or tightening assembly 25 of the load binder, while gear 34 may be driven by a drill or other motor as previously discussed to provide the analogous rapid tightening or loosening of the load binder.

FIG. 12 illustrates the use of load binder 1 as a jack or lift. Relative to the configuration of the load binder assembly shown in FIG. 2, assembly 1 in FIG. 12 utilizes only the right hook style end linkage 28A with one of the plate or foot type end linkages, namely the left end linkage 40B, which was previously described with reference to FIG. 4. Thus, changing the load binder from the FIG. 2 configuration to the FIG. 12 configuration involves simply unscrewing or unthreading left hand threads of end linkage 28B from the left hand threaded portion of rod 26 to separate end linkage 28B from rod 26 and threading the left hand threads 80B of end linkage of 40B into the left hand threads of rod 26. In this jack or lift configuration of FIG. 12 with end linkage 40B joined to rod 26, foot 102 may be positioned such that the left or outer surface 108 serves as a ground engaging bottom surface for engaging the ground 225 or another upwardly facing surface while hook 74 of end linkage 28A may be used to engage a wheeled vehicle 224 or other object or load to be lifted. More particularly, vehicle 224 includes a frame 226 defining a jack hole 228 having a bottom entrance opening 230 through which terminal end 96 and part of leg 94 are inserted upwardly such that hook 74 may support the weight of a portion of vehicle 224. Hook 74 thus serves as a frame engaging or vehicle engaging member which engages frame 226 of vehicle 224. Although element 224 may be a wheeled vehicle, it may also be any other object or load for which load binder 1 in its jack or lift configuration may be suited to lift. Thus, hook 74 may be a load engaging member in which the load 224 is to be lifted by load binder or lift 1.

Load binder, jack or lift 1 as shown in FIG. 12 operates in essentially the same manner as previously described with respect to FIGS. 9, 9A and 9B although instead of tightening a tie down lanyard to secure a load to a vehicle or other structure, drill 208 may be used to rapidly move end linkages 28A and 40B between a relatively expanded or relatively retracted positions in order to expedite the expansion and retraction thereof. Thus, the relatively rapid expansion using the drill or other motor would typically be used to move the end linkages from a fully retracted or relatively retracted position to a more extended position to insert terminal end 96 and leg 94 of hook upwardly into opening 228 via entrance opening 230 and possibly to effect at least some of the lifting of vehicle or object 224. If the ability to lift component 224 is beyond the torque power of the drill or other motor when applied to rotation of gear assembly 36, then the operator may simply use the jack or lift 1 manually as previously discussed in order to provide sufficient torque for lifting the vehicle or load 224 relative to ground 225 via extension of the end linkages. The lifting and lowering of load 224 is represented at Arrow H in FIG. 12. One of skill in the art will readily understand that different end linkages may be used to create a lift similar to lift 1 of FIG. 12. For instance, instead of using a hook type end linkage such as linkage 28A, another plate type linkage such as end linkage 40A may be used or a different configuration may be used which may or may not have a component which extends into a jacking hole such as hole 228. Thus, if end linkage 40A were used in place of end linkage 28A, the configuration may still produce a lift in which the outer surface 108 of end linkage 40A may engage a downwardly facing surface of a vehicle or other load so that lift or jack 1 may be used to lift such a component on top of end linkage 40A.

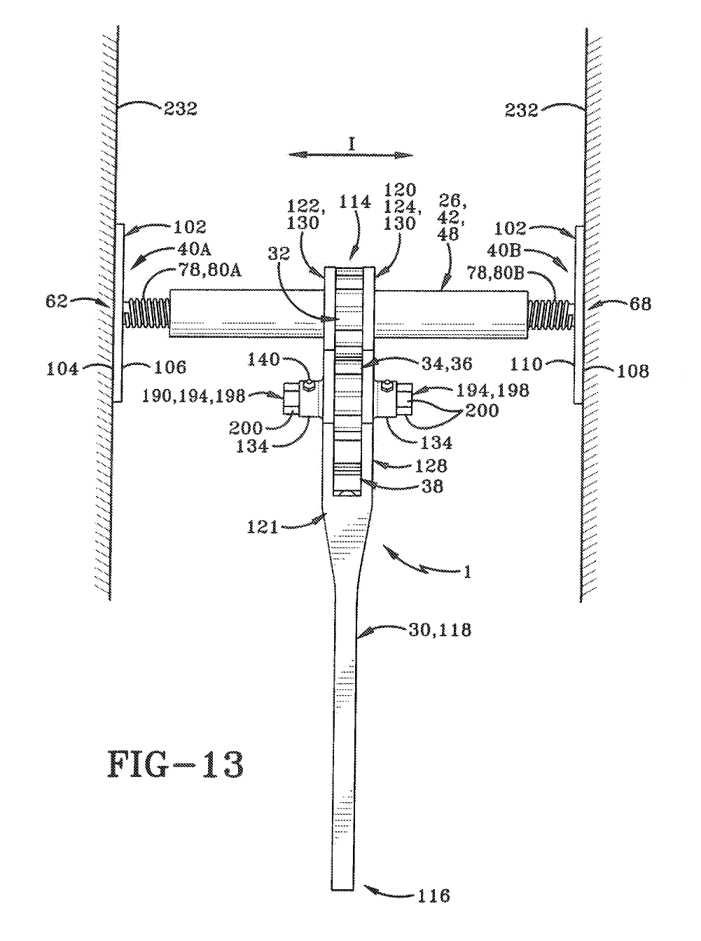

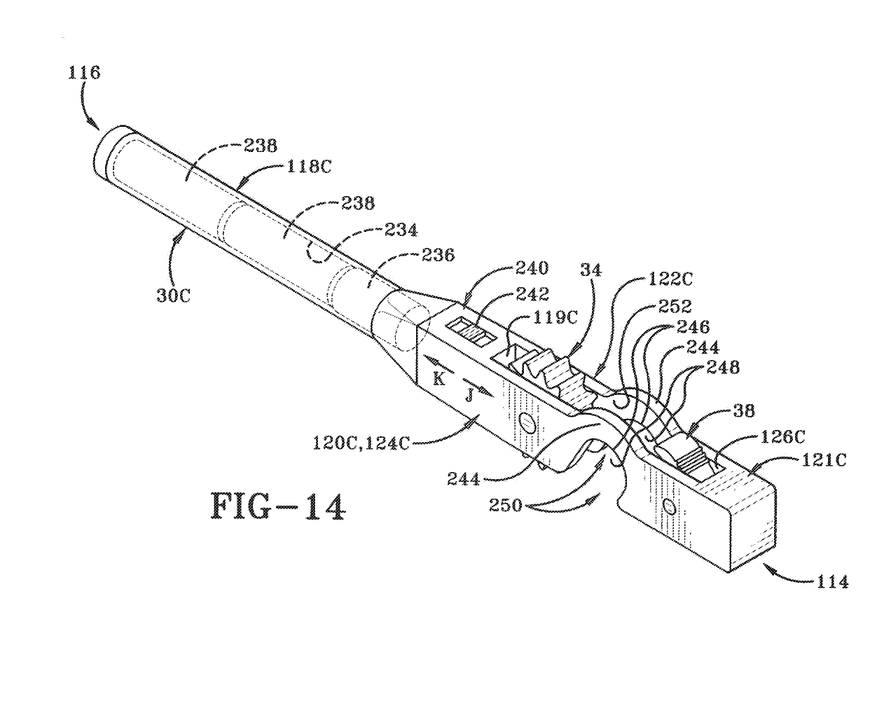

Actually, FIG. 13 illustrates such a lift configuration if FIG. 13 is turned 90 degrees to the left or right. Moreover, FIG. 13 illustrates a usage of the load binder which may be called a spreading device or spreader which is used to push two components or loads 232 away from one another as illustrated via Arrow I in FIG. 13. In the sample shown in FIG. 13, the spreader 1 is used to apply horizontal forces (Arrow I) to the left and right respectively to the two loads 232 in order to push (Arrow I) them apart or spread them apart from one another, which is similar to the lifting or spreading of load 224 in FIG. 12 from ground 225 except for the jacking forces are vertical (FIG. 12) instead of horizontal (FIG. 13). FIG. 13 more particularly illustrates that the spreader 1 is used with two plate type or foot type end linkages 40A and 40B. Thus, relative to the load binder configuration of FIG. 2 and the jack or lift configuration of FIG. 12, right end linkage 28A has been unscrewed or unthreaded from the right handed threads of rod 26 so that end linkage 28A is separated from rod 26 and replaced by end linkage 40A by threading the right hand threads 80A thereof into the right hand threads of rod 26. Spreader 1 operates in a similar fashion as described with respect to jack 1 as well as the earlier description utilizing the motor or drill for rapid expansion and retraction and manual rotation of lever 30 for the slower tightening and loosening with increased torque if necessary.

Although the load binder assembly may be used as a load binder with hooks 74 (FIG. 2), a lift with different end linkages (FIG. 12) or a spreader (FIG. 13) including the use of drill 208 or another motor for rapid expansion and retraction thereof, each of the alternate configurations of the load binder assembly may be operated without the use of a motor such as drill 208 in order to more slowly extend and retract the end linkages. In certain situations, it may be difficult to use a drill or other motor due to limited space, which may be true in the jacking or lift configuration as well as the spreader configuration. Load binder assembly 1 thus provides various options which may be very handy, especially for users who are remote from facilities having electric power and/or other equipment for jacking or lifting or spreading various components or loads.

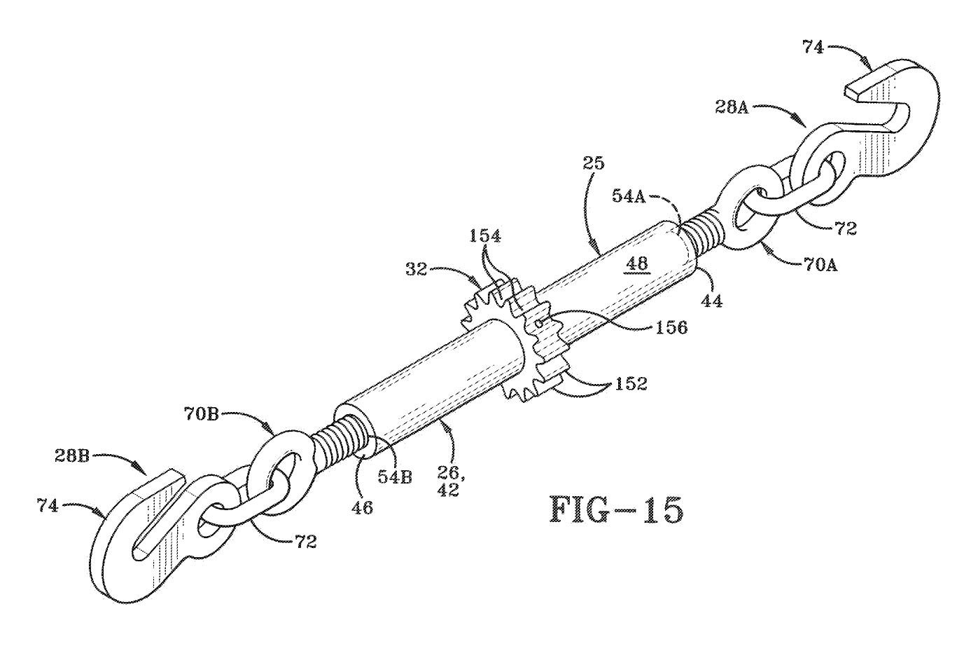

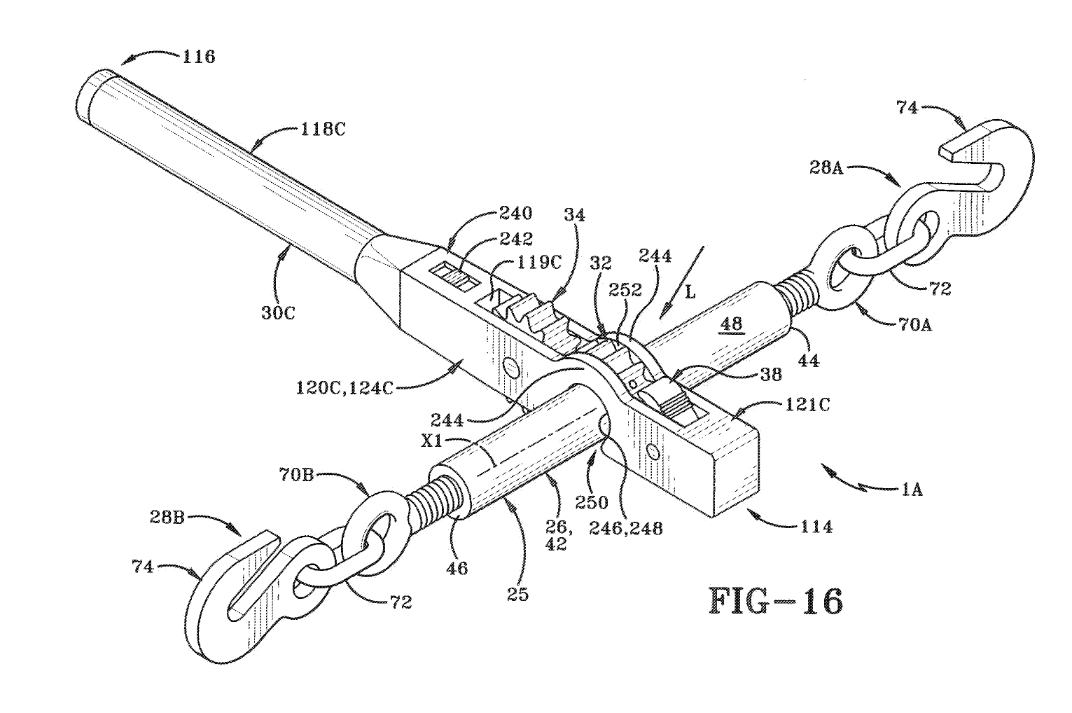

FIG. 14 shows a removable powered handle 30C which may be used with the same extension-retraction assembly 25 (FIG. 15) as previously described (or a different one) to form a load binder or load binder assembly 1A (FIG. 16). FIG. 14 shows lever 30C in a removed, dismounted or separated position in which it is separated from extension-retraction assembly 25, while FIG. 16 shows lever 30C in a joined, mounted or connected position in which lever 30C is mounted on or connected to assembly 25. With primary reference to FIG. 14, lever 30C includes an outer or rear segment 118C which serves as a manual grip section, and an inner or front segment 120C which is secured to and extends forward from the front end of rear segment 118. Rear segment 118C has a front end or forward facing surface 119C. Lever 30C has front and rear ends 114 and 116 defining therebetween a longitudinal direction of the handle and between which it is longitudinally elongated. Rear segment 118C doubles as a housing which defines an interior chamber 234 which houses an electric motor 236 and batteries 238 which are in electrical communication with motor 236 and serve as the power source for operating motor 236. Batteries 238 may be rechargeable batteries.

Lever 30C includes a switch mount 240 on which is mounted an electric switch of motor 236 with a switch control or button 242 which is external and thus manually accessible for turning motor 236 on and off. FIG. 14 shows the switch or control 242 in an off position, with an Arrow J showing an on and forward position of the switch and control, and Arrow K showing an on and reverse position of the switch and control 242.

Front segment 120C includes right and left forks, bars or arms 122C and 124C which define therebetween a space 126C in which are mounted gear 34 and pawl 38 in a manner similar to that previously described. Front segment 120C adjacent front end 114 has a detent mount 121C which is the same as or similar to detent mount 121A shown in FIG. 10, and thus defines a cavity similar to cavity 144A with a spring 186 and ball 188 mounted in the same manner. Front segment 120C further includes left and right bridges intermediate gear 34 and pawl 38. Bridges 244 thus extend forward from adjacent the front of gear 34 to adjacent the rear of pawl 38. Each bridge 244 has an arcuate surface 246 which curves concavely as viewed from the side (in the axial direction) and has a radius of curvature which is slightly larger than that of cylindrical outer surface 48 of rod 26 side wall 42. Each arm 122C and 124C defines a rod receiving space 248 which is partially defined by the respective arcuate surface 246. Each space 248 has a bottom entrance opening 250. Space 126C includes a gear space 252 which is between gear 34 and pawl 38, and also between portions of arms 122C and 124C, including a portion of gear space 252 between bridges 244.

FIG. 16 illustrates the mounting of lever 30C onto assembly 25 by moving (Arrow L) lever 30C substantially perpendicular to rod 26 and axis X1 so that gear 32 is moved into or received within gear space 252 and portions of rod 26 immediately to the left and right of gear 32 are received respectively in the left and right rod receiving spaces 248 via the respective entrance openings 250 such that arcuate surfaces 246 are closely adjacent or in contact with outer surface 48 of wall 42. In the mounted position shown in FIG. 16, gear 32 and 34 mesh with one another in a meshed position and pawl 38 is movable between the neutral or forward and reverse ratcheting positions such that pawl 38 engages gear 32 in a ratcheting manner in the ratcheting positions as previously discussed with earlier embodiments.

Load binder 1A operates similarly to the load binders described previously. In particular, the user may connect hook members 74 to respective tie down connectors and then move handle or lever 30C from its dismounted or separated position to its mounted or connected position in order to lengthen or shorten assembly 25. More particularly, when lever 30C is in the mounted position, the operator may move button 242 either to the forward or rearward position to drive rotation of gear 34 and in turn drive rotation of gear 32 and rod 26 either to retract or extend assembly 25 in a relatively rapid manner as previously described. If necessary, then the user can manually operate load binder 1A by moving the lever 30C back and forth with pawl 38 in the appropriate position either to tighten or loosen the load binder. Once the load binder is sufficiently tightened, lever 30C with all the various components may be moved from the mounted position to the dismounted position. Similarly, after lever 30C has been used to sufficiently loosen or extend assembly 25 such that hooks 74 may be removed from respective tie down connectors, lever 30C may be moved from the mounted to the dismounted position. Thus, load binder 1A operates in a similar manner to load binder 1 in that it allows for rapid extension and retraction of assembly 25 as well as manual tightening or loosening as needed. In addition, the ability to remove lever 30C from assembly 25 serves as an anti-theft feature in that when assembly 25 is secured to tie down connectors in a fully tightened position and lever 30C is removed therefrom, it is difficult to steal the load binder or tie down lanyard or load which is being secured thereby because it is difficult without the use of handle 30C to rotate rod 25 about axis X1 when assembly 25 is under relatively high tension when securing a load. In addition, the removable lever 30C allows lever 30C to be used with multiple assemblies 25, whereby a set of extension-retraction assemblies 25 may be operated by a single handle 30C.

The load binders described above may be modified in various ways within the scope of the present invention. While some of these have been noted above and while others will not be specified in detail, a few of these are now discussed. The load binder may be configured with beveled gears instead of gears 32 and 34, in which case the driven beveled gear would rotate with rod 26 about axis X1 and the drive gear may, for instance, rotate about an axis not parallel to axis X1, such as an axis perpendicular to axis X1. As previously discussed, various types of motors may be used to drive rotation of the drive gear. In addition to the motors shown and/or discussed above, the load binder may be configured, for example, with a motor attached to the side of the lever in a generally permanent fashion.

Moreover, although the sample embodiments use a drive gear and a driven gear which mesh with one another, the relatively rapid rotation of rod 26 with a motor may be achieved with different configurations. For instance, a drive mechanism may include a motor operatively connected to one or more rotatable wheels (such as wheels formed of rubber or another elastomer) such that the motor may drive rotation of the wheels and the outer perimeter of the wheel or wheels may be pressed against the outer surface 48 of rod 26 to drive rotation of rod 26. Alternately, for example, a sprocket may be secured to rod 26 and driven by a chain, or a revolving continuous loop belt may be pressed against outer surface 48 to drive rotation of rod 26. These examples are not exhaustive. Thus, there are other ways of causing the relatively rapid rotation of rod 26.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A load binder comprising:
a load binder rod having a load binder rod first end and a load binder rod second end with left hand threads adjacent the load binder rod first end and right hand threads adjacent the load binder rod second end;
a first gear which is secured to the rod so that the rod and first gear are rotatable together about a first axis;
a lever having a mounted position in which the lever is mounted on and extends outwardly from the rod away from the first axis so that the lever is configured to facilitate rotation of the rod and first gear about the first axis; and
a second gear having a meshed position in which the second gear meshes with the first gear so that rotation of the second gear about a second axis causes rotation of the first gear and rod about the first axis.

2. The load binder of claim 1 further comprising an axle on which the second gear is mounted.

3. The load binder of claim 2 further comprising a bearing or bushing mounted on the axle.

4. The load binder of claim 2 further comprising an end portion of the axle which is accessible to allow the end portion to be driven by a rotational output of a motor.

5. The load binder of claim 4 wherein the end portion has at least one torque drive surface which is not a circular surface concentric about the second axis and is not a flat surface which is substantially perpendicular to the second axis.

6. The load binder of claim 2 further comprising a pawl which is engageable with one of the first and second gears in a ratcheting fashion; a first end linkage having a first threaded portion which threadedly engages the left hand threads; and a second end linkage having a second threaded portion which threadedly engages the right hand threads.

7. The load binder of claim 1 further comprising a pawl which is engageable with one of the first and second gears in a ratcheting fashion.

8. The load binder of claim 7 wherein the pawl has a tightening ratchet position and a loosening ratchet position; and further comprising a detent which alternately holds the pawl in the tightening ratchet position and the loosening ratchet position.

9. The load binder of claim 1 wherein the second gear is mounted on the lever.

10. The load binder of claim 9 wherein the lever and second gear are movable between the mounted position and a dismounted position in which the lever and second gear are dismounted from the rod and first gear.

11. The load binder of claim 1 further comprising a gear mount comprising first and second gear mount arms; wherein the second gear is between the first and second arms.

12. The load binder of claim 1 further comprising an axle on which the second gear is mounted; and a gear mount comprising a bar and an annular boss which extends outwardly from the bar and defines an axle passage which receives the axle.

13. The load binder of claim 1 further comprising a grease fitting adjacent the second gear.

14. The load binder of claim 12 further comprising an axle on which the second gear is mounted; and an axle passage which receives the axle; wherein the grease fitting defines a grease passage which communicates with the axle passage.

15. The load binder of claim 1 further comprising a first end linkage having a first threaded portion which threadedly engages the left hand threads; and a second end linkage having a second threaded portion which threadedly engages the right hand threads.

16. The load binder of claim 15 wherein the first end linkage comprises a first hook; and the second end linkage comprises a second hook.

17. The load binder of claim 15 wherein the first end linkage comprises a linkage rod having a linkage rod first end and a linkage rod second end; the first threaded portion extends adjacent the linkage rod first end; and the first end linkage comprises a foot which extends outwardly from the linkage rod adjacent the linkage rod second end.

18. The load binder of claim 1 further comprising a motor having a rotational output capable of driving rotation of the second gear.

19. A method comprising the steps of:
providing a load binder which comprises a rod having first and second ends with left hand threads adjacent the first end and right hand threads adjacent the second end, a first gear secured to the rod, a first threaded end linkage which threadedly engages the left hand threads, and a second threaded end linkage which threadedly engages the right hand threads, wherein the rod and first gear are rotatable about a first axis; and
rotating about a second axis a second gear meshed with the first gear to cause rotation of the first gear and rod about the first axis relative to the first and second threaded end linkages to cause one of (a) retraction of the first and second end linkages and (b) extension of the first and second end linkages.

20. A method comprising the steps of:
providing a load binder which comprises a rod having first and second ends with left hand threads adjacent the first end and right hand threads adjacent the second end, a first threaded end linkage which threadedly engages the left hand threads, and a second threaded end linkage which threadedly engages the right hand threads; and
rotating the rod with a motor so that rotation of the rod relative to the first and second threaded end linkages causes one of (a) retraction of the first and second end linkages and (b) extension of the first and second end linkages.
